(19) United States
(12) Patent Application Publication
(10) Pub. No.: US 2006/0211786 A1
(43) Pub. Date: Sep. 21, 2006

(54) COMPOSITION OF ULTRAVIOLET CURABLE PAINT

(76) Inventors: Po-Tau Liu, Taipei City (TW); Chan-Ming Liu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,221

(22) Filed: Oct. 11, 2005

(30) Foreign Application Priority Data
Mar. 15, 2005 (TW) 94107800

(51) Int. Cl. C03C 25/10

(52) U.S. Cl. 522/42

(57) ABSTRACT

A composition of ultraviolet curable paint comprising a photo-initiator, an organosilane compound, a binding agent, a catalyst and an ultraviolet curable resin is disclosed. The composition of the present invention has a high surface energy after it is cured by radiation of ultraviolet ray. Therefore, the coating formed by the composition of the present invention can be reworked.

### CROSS-REFERENCE TO RELATED APPLICATION

This application claims the priority benefit of Taiwan application serial no. 94107800, filed on Mar. 15, 2005. All disclosure of the Taiwan application is incorporated herein by reference.

### BACKGROUND OF THE INVENTION

1. Field of Invention

The present invention relates to a composition of paint. More particularly, the present invention relates to a composition of ultraviolet curable paint.

2. Description of Related Art

A composition of ultraviolet curable paint, a brand new green material, was developed in 1970s. Compared with the conventional paints, the ultraviolet curable paint has such advantages as less pollution, higher curable speed, less power consumption, and better property of cured product, and is suitable for temperature-sensitive material and high speed automatic production, etc. In contrast to the conventional paints which are easily volatilized, unable to cure quickly, and harmful to the environment, the ultraviolet curable paint is undoubtedly a desirable substitute for the conventional paint.

Generally, the ultraviolet curable paint is divided into two types: free radical type and cation type. The free radical type is more popular than the cation type. In detail, the photo-initiator in the free radical type ultraviolet curable paint is excited by ultraviolet ray to create free radicals, which then induce the chain reaction between a monomer and an oligomer to form a crosslinked coating.

However, as the conventional ultraviolet curable paint has high crosslink property after curing, there will be few reactive and attachable functional groups on the surface of the ultraviolet coating. Particularly, the surface energy of the ultraviolet coating is pretty low and the surface of the ultraviolet coating is rather smooth so that the coating is not easy to be reworked. As a result, the production yield is reduced. Accordingly, in order to maintain the accepted production yield in 3C industry, the conventional ultraviolet curable paint can only be applied to the appearance of small objects, but not to big objects such as a panel.

### SUMMARY OF THE INVENTION

Accordingly, the present invention is directed to a composition of ultraviolet curable paint. After being cured by radiation of ultraviolet ray, the coating formed by the composition of the present invention has high surface energy, re-workability, and enhanced hardness.

Another objective of the present invention is to provide a composition of ultraviolet curable paint, which is suitable for large size objects such as flat panel displays or notebook computers, and has an improved coating yield.

The present invention provides a composition of ultraviolet curable paint. The composition of ultraviolet curable paint is at least composed of a photo-initiator, an organosilane compound, a binding agent, a catalyst and an ultraviolet curable resin. Wherein, the content of the photo-initiator is 1 to 10 parts by weight based on 100 parts by weight of the composition of ultraviolet curable paint; the content of the organosilane compound is 5 to 20 parts by weight based on 100 parts by weight of the composition of ultraviolet curable paint; the content of the binding agent is 5 to 30 parts by weight based on 100 parts by weight of the composition of ultraviolet curable paint; and the content of the catalyst is 0.1 to 15 parts by weight based on 100 parts by weight of the composition of ultraviolet curable paint.

The present invention also provides another composition of ultraviolet curable paint. The composition of ultraviolet curable paint is at least composed of a photo-initiator, an organosilane compound, a binding agent and an ultraviolet curable resin. Wherein, the content of the photo-initiator is 1 to 10 parts by weight based on 100 parts by weight of the composition of ultraviolet curable paint; the content of the organosilane compound is 5 to 20 parts by weight based on 100 parts by weight of the composition of ultraviolet curable paint; the content of the binding agent is 5 to 30 parts by weight based on 100 parts by weight of the composition of ultraviolet curable paint.

According to the composition of ultraviolet curable paint in the embodiment of the present invention, the organosilane compound is, for example, γ-glycidoxypropyltrimethoxysilane, β-(3,4-epoxycyclohexyl)-ethyl trimethoxysilane) or γ-methacryloxypropyl trimethoxysilane.

According to the composition of ultraviolet curable paint in the embodiment of the present invention, the binding agent is, for example, a metal-hydroxide, silicon oxide or a siloxane compound. Wherein, the metal-hydroxide is, for example, aluminum hydroxide, and the siloxane compound is, for example, tetramethyloxysilane or tetraethyloxysilane.

According to the composition of ultraviolet curable paint in the embodiment of the present invention, the catalyst is, for example, an acid catalyst or an alkali catalyst. Wherein, the acid catalyst is, for example, the hydrochloric acid, the acid value of the oligomer or the acid value of the binding agent; and the alkali catalyst is, for example, sodium hydroxide solution or ammonia.

According to the composition of ultraviolet curable paint in the embodiment of the present invention, the number of the functional groups of the binding agent is more than the number of the functional groups of the organosilane compound; and the functional group is, for example, hydroxyl.

According to the composition of ultraviolet curable paint in the embodiment of the present invention, the ultraviolet curable resin is an oligomer, and the ultraviolet curable resin may also include monomer.

The composition of ultraviolet curable paint according to the embodiment of the present invention further comprises an auxiliary agent, such as a diluting agent, a defoaming agent or a thickening agent, etc.

As the present invention applies the organosilane compound and binding agent in the photo-initiator and the ultraviolet curable resin, the reactive functional group can be formed on the surface so as to make the coating formed by the composition of the present invention re-workable.

Moreover, as the present invention applies the organosilane compound, the binding agent and the catalyst in the photo-initiator and the ultraviolet curable resin, the reactive functional group can be formed on the surface of the ultraviolet coating so as to make the paint formed by the composition of the present invention re-workable. Also, the reaction time is shortened by utilizing the catalyst to catalyze the hydrolysis reaction and the condensation reaction between the organosilane compound and the binding agent.

In addition, as the organosilane compound forms an organic coating with the ultraviolet curable resin, such as a monomer or an oligomer, and the organic coating further forms a stable structure with the binding agent, the hardness of the coating formed by the ultraviolet curable paint of the present invention is thus improved effectively.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates the sol-gel reaction mechanism of the organosilane compound.

FIG. 2 illustrates the compositions of the preferred embodiment of the present invention and the comparative sample.

### DESCRIPTION OF EMBODIMENTS

The composition of ultraviolet curable paint of the present invention is at least composed of a photo-initiator, an organosilane compound, a binding agent and an ultraviolet curable resin. Preferably, the composition of the ultraviolet curable paint of the present invention further comprises a catalyst that can shorten the reaction time. The content of the photo-initiator is 1 to 10 parts by weight based on 100 parts by weight of the composition of ultraviolet curable paint. The content of the organosilane compound is 5 to 20 parts by weight based on 100 parts by weight of the composition of ultraviolet curable paint. The content of the binding agent is 5 to 30 parts by weight based on 100 parts by weight of the composition of ultraviolet curable paint, The content of the catalyst is 0.1 to 15 parts by weight based on 100 parts by weight of the composition of ultraviolet curable paint. In the composition of ultraviolet curable paint of the present invention, the number of the functional groups of the binding agent is preferred to be greater than that of the organosilane compound, and more preferably, the functional group is hydroxyls. In the composition of ultraviolet curable paint of the present invention, the catalyst can be an acid catalyst or an alkali catalyst. Preferably, the catalyat is an acid catalyst. More preferably, the acid catalyst is, for example, hydrochloric acid, the acid value of the oligomer or the binding agent. Preferably, the alkali catalyst is, for example, sodium hydroxide solution or ammonia. The organosilane compound of the composition of ultraviolet curable paint of the present invention is γ-glycidoxypropyltrimethoxysilane, β-(3,4-epoxycyclohexyl)-ethyl trimethoxysilane or γ-methacryloxypropyl trimethoxysilane. Preferably, the binding agent of the composition of ultraviolet curable paint of the present invention is, for example, a metal-hydroxide, silicon oxide or a siloxane compound. More preferably, the metal-hydroxide is, for example, aluminum hydroxide, and the siloxane compound is, for example, tetramethyloxysilane or tetraethyloxysilane. Preferably, the ultraviolet curable resin of the composition of ultraviolet curable paint of the present invention is an oligomer, and more preferably, the ultraviolet curable resin further comprises a monomer. Preferably, the composition of ultraviolet curable paint of the present invention further comprises an auxiliary agent. More preferably, the auxiliary agent is a diluting agent, a defoaming agent or a thickening agent.

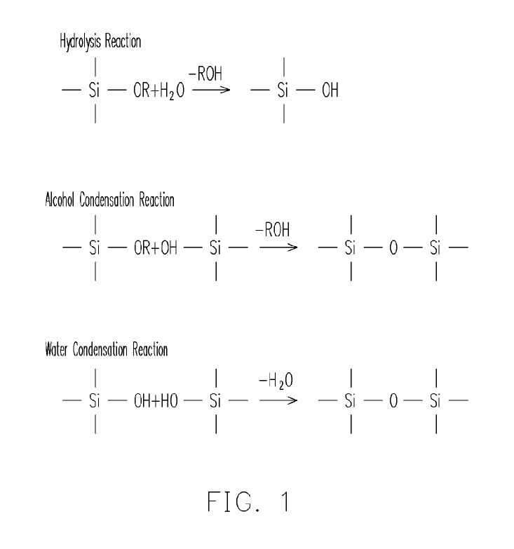

FIG. 1 illustrates the sol-gel reaction mechanism of the organosilane compound. The mechanism includes the hydrolysis reaction, the alcohol condensation reaction and the water condensation reaction. The present invention applies the sol-gel reaction theory to form the composition of ultraviolet curable paint of the present invention that has reworkability.

Through the modification technique of chemical formulation, the present invention increases the surface energy of the ultraviolet coating by adding the organosilane compound and the binding agent into the photo-initiator and the ultraviolet curable resin Accordingly, re-workability of the ultraviolet coating can be achieved. With reference to formula I shown in FIG. 1, the organosilane compound has a silanol group, i.e., —SiOH after it is hydrolyzed. On the surface of the binding agent or hydrolyzed binding agent, there is hydroxyl group, i.e. —OH which may come from aluminum hydroxide or silanol group which may come from tetramethyloxysilane or tetraethyloxysilane. As shown in formula II and formula III of FIG. 1, the un-hydrolyzed silane group (—SiOR) or the hydrolyzed silanol group (—SiOH) on the surface of the organosilane compound can have condensation reaction with the hydroxyl group or silanol group on the surface of the binding agent. Accordingly, the organosilane compound combines with the binding agent. Furthermore, in the present invention, the number of the functional groups on the binding agent is design to be greater than the number of that on the organosilane compound. Therefore, the coating formed by the ultraviolet curable paint of the present invention still has some unreacted functional groups on the surface of the binding agent. The unreacted functional groups on the surface of the binding agent can react with the subsequently coated ultraviolet curable paint so as to form a reworked coating. In other words, the surface energy of the coating formed by the ultraviolet curable paint of the present invention is improved, and a reworkable ultraviolet curable paint is thus provided.

Through the addition of the organosilane compound, the binding agent, and the catalyst into the photo-initiator and the ultraviolet curable resin, the present invention improves the surface energy of the coating formed by the ultraviolet curable paint of the present invention, and thus the coating can be reworked. The principle is that the organosilane compound and the binding agent can undergo hydrolyzation reaction and condensation reaction with the aid of the catalyst. Moreover, the functional groups of the organosilane compound or the hydrolyzed organosilane compound, such as the silanol, can have condensation reaction with the functional groups of the binding agent or the hydrolyzed binding agent, such as hydroxyl or silanol. Therefore, as the number of the functional groups of the binding agent is greater than that of the organosilane compound, there will remain some unreacted functional groups on the binding agent of the coating. The unreacted functional groups will facilitate the subsequent paint to adhere to the surface of the coating. Thus, the coating formed by the ultraviolet curable paint of the present invention can be reworked if its quality is not good enough. In addition, the reaction time is reduced due to the catalysis of the catalyst in the present invention.

As the organosilane compound has dual bonding or epoxy structure, it can form chemical bondings with the monomer or the oligomer to obtain the organosilane coating. Moreover, the organosilane coating and the nano-molecules of the inorganic binding agent can further form a stable coating. Therefore, the hardness of the coating can be improved effectively.

In the following, an preferred embodiment according to the present invention and a comparative example are illustrated to verify the reworkability of the ultraviolet curable paint of the present invention.

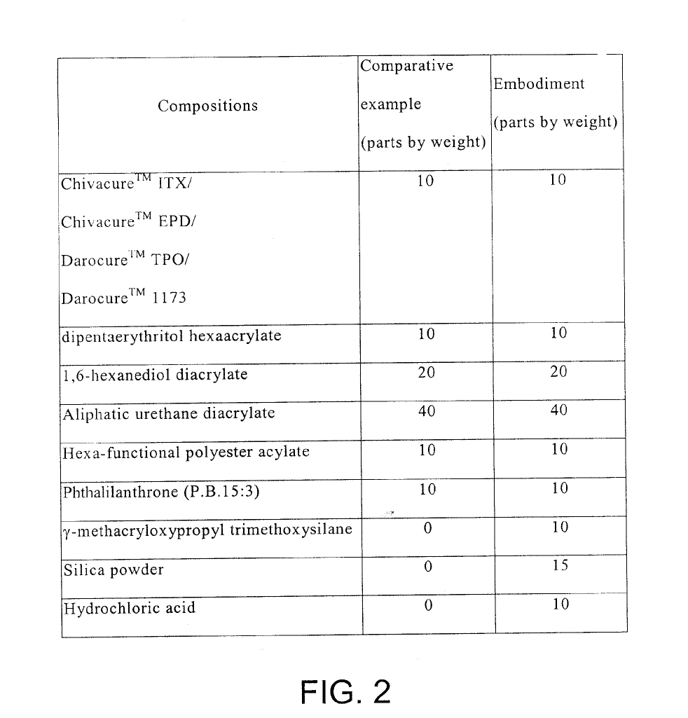

The compositions of the preferred embodiment of the present invention and the comparative sample are listed in FIG. 2. The components are evenly mixed and diluted with 1:1 BAC/IPA, respectively. After the polycarbonate (PC) substrate is coated by the above two, the drying is performed for 10 minutes at 70° C. Next, the PC substrate is irradiated by ultraviolet ray, and the amount of the overall irradiation is, for example, 500˜650 mJ/cm². Then, the cross-cut test for the adhesion is carried out. Both the test results of the preferred embodiment of the present invention and the comparative example are 5B. As for the pencil hardness test, the pencil hardness of the comparative example is H, and that of the preferred embodiment of the present invention is 2H. The result indicates that the hardness of the preferred embodiment of the present invention is indeed greater than that of the comparative example. Thereafter, the coating and drying steps aforementioned are repeated, the then cross-cut test is carried out again to verifiy the reworkability. The test result of the comparative example is 0B, which indicates that the coating formed by the comparative example can not be reworked. As for the coating formed by the preferred embodiment of the present invention, it indeed can be reworked successfully.

In summary, the composition of ultraviolet curable paint of the present invention at least has the following advantages.

1. The present invention improves the surface energy of the coating by adding the organosilane compound and the binding agent into the photo-initiator and the ultraviolet curable resin so that the ultraviolet curable paint of the present invention has good re-workability.

2. As the organosilane compound has dual bonding or epoxy structure, it can form chemical bondings with the ultraviolet curable resin. Moreover, the organosilane coating and the nano-molecules of the inorganic binding agent can further form a stable coating. Therefore, the hardness of the coating can be improved effectively.

3. The composition of ultraviolet curable paint of the present invention is suitable for applying to large size objects, such as a flat panel display or a notebook computer, of which the production yield is also improved significantly.

It will be apparent to those skilled in the art that various modifications and variations can be made to the present invention without departing from the scope or spirit of the invention. In view of the foregoing, it is intended that the present invention cover modifications and variations of this invention provided they fall within the scope of the following claims and their equivalents.

What is claimed is:

1. A composition of ultraviolet curable paint, comprising:
1 to 10 parts by weight of a photo-initiator, based on 100 parts by weight of the composition of ultraviolet curable paint;
5 to 20 parts by weight of an organosilane compound, based on 100 parts by weight of the composition of ultraviolet curable paint;
5 to 30 parts by weight of a binding agent, based on 100 parts by weight of the composition of ultraviolet curable paint;
0.1 to 15 parts by weight of a catalyst, based on 100 parts by weight of the composition of ultraviolet curable paint; and
an ultraviolet curable resin.

2. The composition of ultraviolet curable paint as claimed in claim 1, wherein the catalyst is an acid catalyst or an alkali catalyst.

3. The composition of ultraviolet curable paint as claimed in claim 1, wherein the organosilane compound is γ-glycidoxypropyltrimethoxysilane, β-(3,4-epoxycyclohexyl)-ethyl trimethoxysilane or γ-methacryloxypropyl trimethoxysilane.

4. The composition of ultraviolet curable paint as claimed in claim 1, wherein the binding agent is a metal-hydroxide, silicon oxide or a siloxane compound.

5. The composition of ultraviolet curable paint as claimed in claim 4, wherein the metal-hydroxide is aluminum hydroxide.

6. The composition of ultraviolet curable paint as claimed in claim 4, wherein the siloxane compound is tetramethyloxysilane or tetraethyloxysilane.

7. The composition of ultraviolet curable paint as claimed in claim 1, wherein the number of the functional groups of the binding agent is more than the number of the functional groups of the organosilane compound.

8. The composition of ultraviolet curable paint as claimed in claim 7, wherein the functional groups are hydroxyls.

9. The composition of ultraviolet curable paint as claimed in claim 1, wherein the ultraviolet curable resin is an oligomer.

10. The composition of ultraviolet curable paint as claimed in claim 9, wherein the ultraviolet curable resin further comprises a monomer.

11. The composition of ultraviolet curable paint as claimed in claim 1, further comprising an auxiliary agent.

12. The composition of ultraviolet curable paint as claimed in claim 11, wherein the auxiliary agent is a diluting agent, a defoaming agent or a thickening agent.

13. A composition of ultraviolet curable paint, comprising:
1 to 10 parts by weight of a photo-initiator, based on 100 parts by weight of the composition of ultraviolet curable paint;
5 to 20 parts by weight of an organosilane compound, based on 100 parts by weight of the composition of ultraviolet curable paint;
5 to 30 parts by weight of a binding agent, based on 100 parts by weight of the composition of ultraviolet curable paint; and
an ultraviolet curable resin.

14. The composition of ultraviolet curable paint as claimed in claim 13, further comprising 0.1 to 15 parts by weight of a catalyst, based on 100 parts by weight of the composition of ultraviolet curable paint.

15. The composition of ultraviolet curable paint as claimed in claim 14, wherein the catalyst is an acid catalyst or an alkali catalyst.

16. The composition of ultraviolet curable paint as claimed in claim 13, wherein the organosilane compound is γ-glycidoxypropyltrimethoxysilane, β-(3,4-epoxycyclohexyl)-ethyl trimethoxysilane or γ-methacryloxypropyl trimethoxysilane.

17. The composition of ultraviolet curable paint as claimed in claim 13, wherein the binding agent is a metal-hydroxide, silicon oxide or a siloxane compound.

18. The composition of ultraviolet curable paint as claimed in claim 13, wherein the number of the functional groups of the binding agent is more than the number of the functional groups of the organosilane compound.

19. The composition of ultraviolet curable paint as claimed in claim 18, wherein the functional group is a hydroxyl.

20. The composition of ultraviolet curable paint as claimed in claim 13, wherein the ultraviolet curable resin is an oligomer.

21. The composition of ultraviolet curable paint as claimed in claim 20, wherein the ultraviolet curable resin further comprises a monomer.

22. The composition of ultraviolet curable paint as claimed in claim 13, further comprising an auxiliary agent.
